(19) United States
(12) Patent Application Publication
(10) Pub. No.: US 2010/0315146 A1
(43) Pub. Date: Dec. 16, 2010

(54) EXTERNAL FREQUENCY ADJUSTMENT METHODS AND SYSTEMS

(76) Inventor: Ming-De YEN, Taipei County (TW)

Correspondence Address: BIRCH STEWART KOLASCH & BIRCH, PO BOX 747, FALLS CHURCH, VA, 22040-0747, US

(21) Appl. No.: 12/569,706

(22) Filed: Sep. 29, 2009

(30) Foreign Application Priority Data
Jun. 12, 2009 (TW) 98119679

(51) Int. Cl. G06F 1/04

(52) U.S. Cl. 327/291

(57) ABSTRACT

External frequency adjustment methods and systems are provided. First, an external frequency of an electronic device is increased from an initial frequency until a processing unit fails to properly operate, and a maximum first frequency value at which the processing unit can properly operate is recorded as the external frequency. The electronic device is enabled to reboot, and at least one peripheral device is initiated and operated according to the first frequency value. It is determined whether the peripheral device is properly operating at the first frequency value. When the peripheral device can not properly operate at the first frequency value, the electronic device is enabled to reboot, the first frequency value is subtracted by a predefined value to obtain a second frequency value, and the second frequency value is set as the external frequency, wherein the second frequency value is the maximum frequency value at which the processing unit can properly operate.

### CROSS REFERENCE TO RELATED APPLICATIONS

This Application claims priority of Taiwan Patent Application No. 098119679, filed on Jun. 12, 2009, the entirety of which is incorporated by reference herein.

### BACKGROUND OF THE INVENTION

1. Field of the Invention

The disclosure relates generally to external frequency adjustment methods and systems, and, more particularly to external frequency adjustment method and systems that automatically adjust the external frequency of an electronic device, such that a processing unit and/or at least one peripheral device of the electronic device can properly operate.

2. Description of the Related Art

An electronic device, such as a computer system may have a motherboard, and elements, such as a processing unit and peripheral devices, such as a memory unit, a display unit, a south bridge chip, and a north bridge chip set thereon which perform respective operations. The elements can be connected via a bus. The motherboard may have a clock generator to generate a clock signal, and provide the clock signal to the elements. The elements can perform respective operations and communications based on the clock signal.

A main frequency, an external frequency, and frequency-multiplication are all clock-related terms. The main frequency is the internal working frequency of the processing unit. The external frequency is the base frequency of the electronic device. Frequency-multiplication equals to the main frequency divided by the external frequency. Generally, an over-clocking can be performed on the motherboard of the electronic device to raise the work efficiency of related elements, thereby improving performance of the electronic device.

Conventionally, only the operation status of the processing unit is considered for over-clocking techniques. For example, the external frequency of the electronic device can be to progressively raised (maximum external frequency) until operation of the processing unit fails. However, since an electronic device normally has a number of elements, the maximum external frequency of the processing unit may not be the maximum external frequency of the other elements in the electronic device. Consequently, the electronic device may crash when performing the conventional over-clocking technique if the maximum external frequency of the processing unit is not the maximum external frequency of the other elements in the electronic device.

### BRIEF SUMMARY OF THE INVENTION

External frequency adjustment methods and systems are provided.

In an embodiment of an external frequency adjustment method, an external frequency of an electronic device is increased from an initial frequency until a processing unit fails to properly operate, and a maximum first frequency value at which the processing unit can properly operate is recorded as the external frequency. It results in the electronic device being enabled to reboot, and at least one peripheral device being initiated and operated according to the first frequency value. It is next determined whether the peripheral device is properly operating at the first frequency value. When the peripheral device can not properly operate at the first frequency value, the electronic device is enabled to reboot, the first frequency value is subtracted by a predefined value to obtain a second frequency value, and the second frequency value is set as the external frequency, wherein the second frequency value is the maximum frequency value at which the processing unit can properly operate.

In an embodiment of an external frequency adjustment method, a frequency-multiplication of an electronic device is determined as a plurality of specific frequency-multiplication values. The electronic device is booted according to each of the specific frequency-multiplication values, and an external frequency of the electronic device is increased from an initial frequency until a processing unit fails to properly operate, and a specific frequency value is recorded as the external frequency, wherein the recorded specific frequency value is the maximum frequency value at which the processing unit can properly operate. Then, the maximum specific frequency value is selected from the specific frequency values corresponding to the respective specific frequency-multiplication values, and the maximum specific frequency value is set as the external frequency.

An embodiment of an external frequency adjustment system for use in an electronic device at least includes a processing unit, at least one peripheral device, and a frequency adjustment module. The frequency adjustment module increases an external frequency of the electronic device from an initial frequency until a processing unit fails to properly operate, and records a maximum first frequency value at which the processing unit can properly operate as the external frequency. The frequency adjustment module enables the electronic device to reboot, and initiates and operates the peripheral device according to the first frequency value. The frequency adjustment module determines whether the peripheral device is properly operating at the first frequency value. When the peripheral device can not properly operate at the first frequency value, the frequency adjustment module enables the electronic device to reboot, subtracts the first frequency value by a predefined value to obtain a second frequency value, and sets the second frequency value as the external frequency, wherein the second frequency value is the maximum frequency value at which the processing unit can properly operate.

An embodiment of an external frequency adjustment system for use in an electronic device at least includes a processing unit, and a frequency adjustment module. The frequency adjustment module determines a frequency-multiplication of the electronic device as a plurality of specific frequency-multiplication values, and enables the electronic device to boot according to each of the specific frequency-multiplication values. Under the respective specific frequency-multiplication value, the frequency adjustment module raises an external frequency of the electronic device from an initial frequency until a processing unit fails to properly operate, and records a specific frequency value as the external frequency, wherein the recorded specific frequency value is the maximum frequency value at which the processing unit can properly operate. The frequency adjustment module selects the maximum specific frequency value from the specific frequency values corresponding to the respective specific frequency-multiplication values, and sets the maximum specific frequency value as the external frequency.

External frequency adjustment methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an external frequency adjustment system of the invention;

FIG. 2 is a flowchart of an embodiment of an external frequency adjustment method of the invention; and

FIG. 3 is a flowchart of another embodiment of an external frequency adjustment method of the invention.

### DETAILED DESCRIPTION OF THE INVENTION

External frequency adjustment methods and systems are provided.

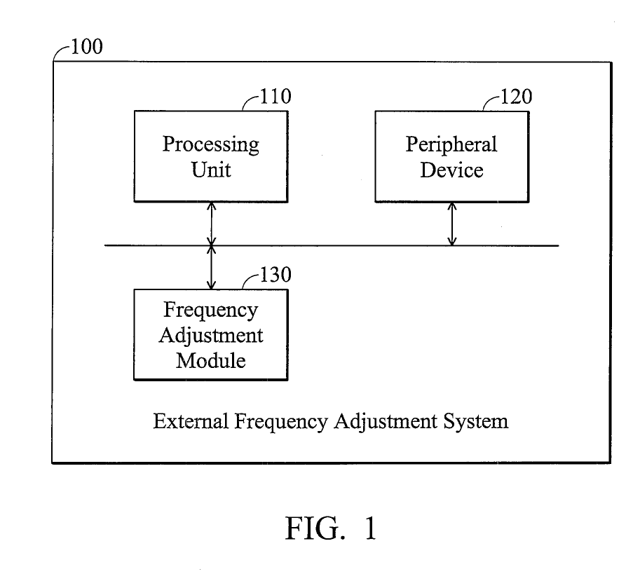

FIG. 1 is a schematic diagram illustrating an embodiment of an external frequency adjustment system of the invention. The external frequency adjustment system 100 can be used in an electronic device, such as a computer system.

The external frequency adjustment system 100 comprises a processing unit 110, at least one peripheral device 120, and a frequency adjustment module 130. The peripheral device 120 may comprise a memory unit, a display unit, a south bridge chip, and/or a north bridge chip. The frequency adjustment module 130 performs the external frequency adjustment method of the invention, which will be discussed further in the following paragraphs. The processing unit 110, the peripheral device 120, and the frequency adjustment module 130 can be connected with each other via at least one bus. It is understood that, the external frequency adjustment system 100 may further comprise a clock generator (not shown in FIG. 1) to generate a clock signal to the processing unit 110 and the peripheral device 120. The frequency adjustment module 130 can control the clock generator to generate a clock signal with different frequencies, thus to adjust the external frequency of the electronic device. In some embodiments, the frequency adjustment module 130 can be implemented via software or hardware. In some embodiments, the frequency adjustment module 130 may be in the clock generator.

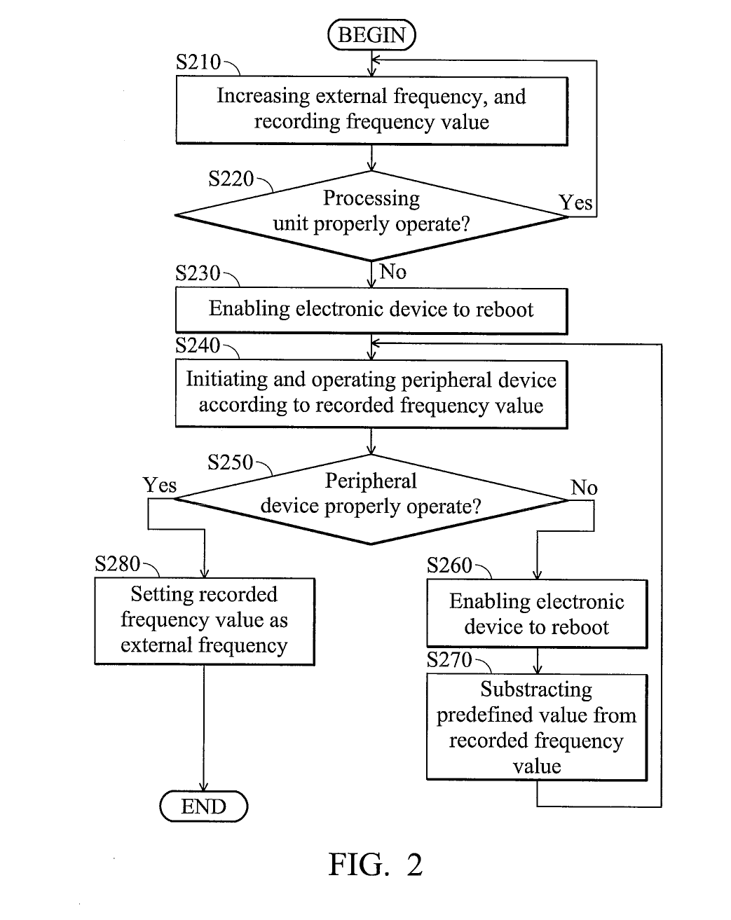

FIG. 2 is a flowchart of an embodiment of an external frequency adjustment method of the invention. The external frequency adjustment method can be used for an electronic device, such as a computer system.

In step S210, the external frequency of the electronic device is increased from an initial frequency by increasing a first predefined value, such as 1 MHz, and the frequency value is recorded. It is understood that, in some embodiments, the recorded frequency value is the maximum frequency value at which the processing unit of the electronic device can properly operate. In step S220, it is determined whether the processing unit can properly operate at the current frequency value. If the processing unit can properly operate at the current frequency value (Yes in step S220), the procedure returns to step S210, and the external frequency of the electronic device is continuously increased until a processing unit fails to properly operate. If the processing unit cannot properly operate at the current frequency value (No in step S220), in step S230, the electronic device is enabled to reboot. It is understood that, the determination of whether the processing unit can properly operate at the current frequency value can be performed using a watchdog mechanism. After a predefined interval, if the processing unit cannot generate related signals or responses, it is determined the processing unit can not properly operate at the current frequency value. Consequently, the electronic device would be enabled to reboot.

After the electronic device is rebooted, in step S240, the peripheral device of the electronic device is initiated and operated according to the recorded frequency value (the maximum frequency value at which the processing unit of the electronic device can properly operate), and in step S250, it is determined whether the peripheral device can properly operate at the frequency value. It is understood that, in some embodiments, the recorded frequency value can be to first subtracted by a specific value after the electronic device is rebooted, such that the peripheral device can be to initiated and properly operated. When the peripheral device can not properly operate at the frequency value (No in step S250), in step S260, the electronic device is enabled to reboot, and after the electronic device is rebooted, in step S270, the recorded frequency value is subtracted by a second predefined value, such as 10 MHz, and recorded. Then, steps S240 to S270 are repeated until the peripheral device can properly operate at the recorded frequency value. When the peripheral device can properly operate at the frequency value (Yes in step S250), in step S280, the recorded frequency value is set as the external frequency of the electronic device. Similarly, the determination of whether the peripheral device can properly operate at the recorded frequency value can be performed using a watchdog mechanism. After a predefined interval, if the peripheral device can not generate related signals or responses, it is determined the peripheral device can not properly operate at the recorded frequency value. Consequently, the electronic device is enabled to reboot.

It is understood that, in some embodiments, before the adjustment of the external frequency of the electronic device, at least one parameter, such as the frequency-multiplication, the voltage, and/or the refresh cycle time of the memory unit related to over-clocking can be to adjusted. Then, the electronic device is booted based on the adjusted parameter, and the subsequent adjustment of the external frequency is performed. In some embodiments, the adjustment of the parameter related to over-clocking can be to reduce the frequency-multiplication. In some embodiments, the adjustment of the parameter related to over-clocking can be raise of the voltage. In some embodiments, the adjustment of the parameter related to over-clocking can be to raise the refresh cycle time of the memory unit. It is noted that, the parameters and the adjustment manners thereof are examples of the embodiment, and the present invention is not limited thereto.

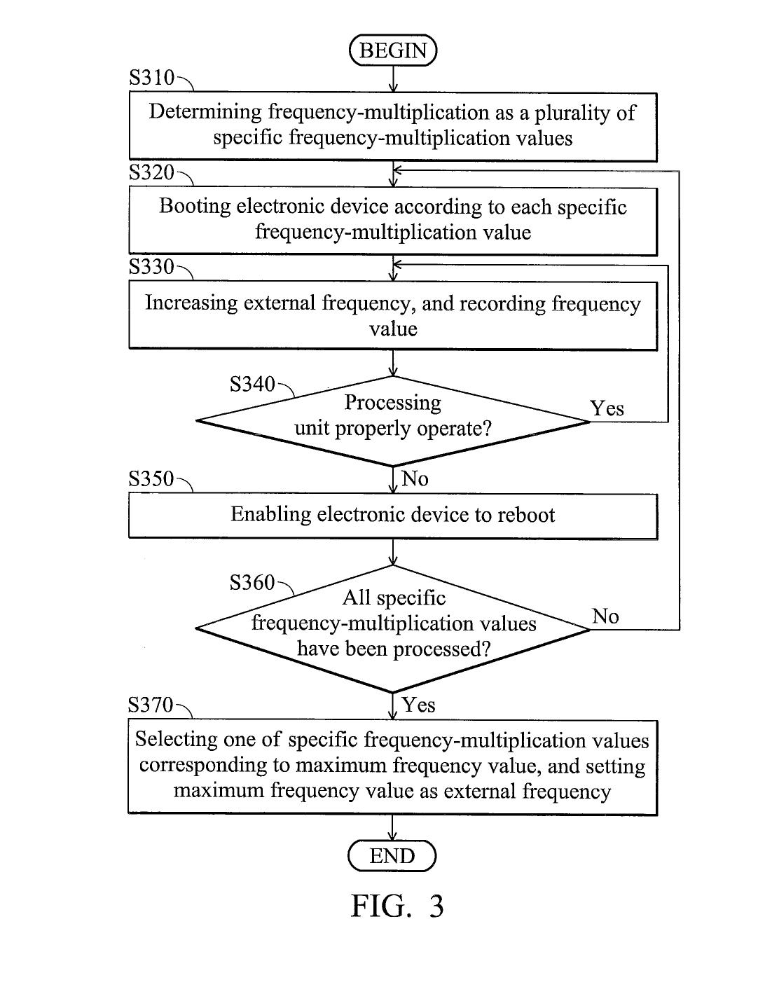

FIG. 3 is a flowchart of another embodiment of an external frequency adjustment method of the invention. The external frequency adjustment method can be used for an electronic device, such as a computer system.

In step S310, the frequency-multiplication of the electronic device is determined as a plurality of specific frequency-multiplication values. For example, if the original value of the frequency-multiplication of the electronic device is X, the specific frequency-multiplication values of the electronic device can be determined as X−1, X, and X+1. Then, in step S320, for one of the specific frequency-multiplication values, the electronic device is booted according to the specific frequency-multiplication value, and in step S330, the external frequency of the electronic device is increased from an initial frequency by increasing a first predefined value, such as 1 MHz, and the frequency value is recorded. It is understood that, in some embodiments, the recorded frequency value is the maximum frequency value at which the processing unit of the electronic device can properly operate. In step S340, it is determined whether the processing unit can properly operate at the current frequency value. If the processing unit can properly operate at the current frequency value (Yes in step S340), the procedure returns to step S330, the external frequency of the electronic device is continuously increased until a processing unit fails to properly operate. If the processing unit cannot properly operate at the current frequency value (No in step S340), in step S350, the electronic device is enabled to reboot. It is understood that, the determination of whether the processing unit can properly operate at the current frequency value can be performed using a watchdog mechanism. After a predefined interval, if the processing unit cannot generate related signals or responses, it is determined the processing unit can not properly operate at the current frequency value. Consequently, the electronic device is enabled to reboot.

After the electronic device is rebooted, in step S360, it is determined whether all of the specific frequency-multiplication values (the adjustments of external frequency for the respective specific frequency-multiplication values) have been processed. If at least one of the specific frequency-multiplication values has not been processed (No in step S360), the procedure returns to step S320, wherein another specific frequency-multiplication value is selected, and the adjustment of external frequency is accordingly performed. If all of the specific frequency-multiplication values have been processed (Yes in step S360), in step S370, one of the specific frequency-multiplication values is selected according to the maximum frequency value among the recorded frequency values corresponding to the respective specific frequency-multiplication values, and the maximum frequency value corresponding to the selected specific frequency-multiplication value is set as the external frequency of the electronic device.

It is understood that, in some embodiments, after the selected specific frequency-multiplication value is determined, the electronic device can be booted based on the selected specific frequency-multiplication value, and steps S210 to step S280 in FIG. 2 can be performed.

Therefore, the external frequency adjustment methods and systems can automatically adjust the external frequency of the electronic device, such that the processing unit and/or the peripheral device of the electronic device can properly operate. Additionally, related parameters related to over-clocking can be further considered to assist in adjustment of the external frequency.

External frequency adjustment methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An external frequency adjustment method for use in an electronic device comprising a processing unit and at least one peripheral device, comprising:
increasing an external frequency of the electronic device from an initial frequency until a processing unit fails to properly operate, and recording a maximum first frequency value at which the processing unit can properly operate as the external frequency;
enabling the electronic device to reboot, and initiating and operating the peripheral device according to the first frequency value;
determining whether the peripheral device is properly operating at the first frequency value; and
when the peripheral device can not properly operate at the first frequency value, enabling the electronic device to reboot, subtracting a predefined value from the first frequency value to obtain a second frequency value, and setting the second frequency value as the external frequency, wherein the second frequency value is the maximum frequency value at which the processing unit can properly operate.

2. The method of claim 1, further comprising:
enabling the electronic device to reboot, and initiating and operating the peripheral device according to the second frequency value;
determining whether the peripheral device is properly operating at the second frequency value; and
when the peripheral device can not properly operate at the second frequency value, enabling the electronic device to reboot, subtracting the predefined value from the second frequency value to obtain a third frequency value, and setting the second frequency value as the external frequency, wherein the third frequency value is the maximum frequency value at which the processing unit can properly operate.

3. The method of claim 2, further comprising when the peripheral device is properly operating at the second frequency value, setting the second frequency value as the external frequency, wherein the second frequency value is the maximum frequency value at which the processing unit can properly operate.

4. The method of claim 1, further comprising:
adjusting at least one parameter related to over-clocking of the electronic device; and
booting the electronic device based on the adjusted parameter, and performing the adjustment process of the external frequency.

5. The method of claim 4, wherein the parameter comprises a frequency-multiplication, a voltage, or a refresh cycle time of a memory unit of the electronic device.

6. The method of claim 5, wherein the adjustment of the parameter is performed by reducing the frequency-multiplication.

7. The method of claim 5, wherein the adjustment of the parameter is performed by raising the voltage.

8. The method of claim 5, wherein the adjustment of the parameter is performed by raising the refresh cycle time of a memory unit.

9. The method of claim 1, further comprising:
determining a frequency-multiplication of the electronic device as a plurality of specific frequency-multiplication values;
booting the electronic device according to each of the specific frequency-multiplication values, increasing the external frequency of the electronic device from the initial frequency until a processing unit fails to properly operate, and recording a specific frequency value as the external frequency, wherein the recorded specific frequency value is the maximum frequency value at which the processing unit can properly operate;
selecting one of the specific frequency-multiplication values corresponding to the maximum specific frequency value among the recorded specific frequency values corresponding to the respective specific frequency-multiplication values; and
booting the electronic device based on the selected specific frequency-multiplication value, and re-performing the adjustment process of the external frequency.

10. The method of claim 1, wherein the peripheral device comprises a memory unit, a display unit, a south bridge chip, or a north bridge chip.

11. An external frequency adjustment method for use in an electronic device comprising a processing unit, comprising:
determining a frequency-multiplication of the electronic device as a plurality of specific frequency-multiplication values;
booting the electronic device according to each of the specific frequency-multiplication values, increasing an external frequency of the electronic device from an initial frequency until a processing unit fails to properly operate, and recording a specific frequency value, wherein the recorded specific frequency value is the maximum frequency value at which the processing unit can properly operate as the external frequency;
selecting the maximum specific frequency value from the specific frequency values corresponding to the respective specific frequency-multiplication values; and
setting the maximum specific frequency value as the external frequency.

12. The method of claim 11, further comprising booting the electronic device based on the specific frequency-multiplication value corresponding to the maximum specific frequency value, and re-performing the adjustment process of the external frequency.

13. An external frequency adjustment system for use in an electronic device, comprising:
a processing unit;
at least one peripheral device; and
a frequency adjustment module increasing an external frequency of the electronic device from an initial frequency until a processing unit fails to properly operate, recording a maximum first frequency value at which the processing unit can properly operate as the external frequency, enabling the electronic device to reboot, initiating and operating the peripheral device according to the first frequency value, determining whether the peripheral device is properly operating at the first frequency value, and when the peripheral device can not properly operate at the first frequency value, enabling the electronic device to reboot, subtracting a predefined value from the first frequency value to obtain a second frequency value, and setting the second frequency value as the external frequency, wherein the second frequency value is the maximum frequency value at which the processing unit can properly operate.

14. The system of claim 13, wherein the frequency adjustment module further enables the electronic device to reboot, initiates and operates the peripheral device according to the second frequency value, and determines whether the peripheral device is properly operating at the second frequency value, and when the peripheral device can not properly operate at the second frequency value, the frequency adjustment module enables the electronic device to reboot, subtracts the predefined value from the second frequency value to obtain a third frequency value, and sets the second frequency value as the external frequency, wherein the third frequency value is the maximum frequency value at which the processing unit can properly operate.

15. The system of claim 14, wherein when the peripheral device is properly operating at the second frequency value, the frequency adjustment module sets the second frequency value as the external frequency, wherein the second frequency value is the maximum frequency value at which the processing unit can properly operate.

16. The system of claim 13, wherein the frequency adjustment module further adjusts at least one parameter related to over-clocking of the electronic device, boots the electronic device based on the adjusted parameter, and performs the adjustment process of the external frequency.

17. The system of claim 16, wherein the parameter comprises a frequency-multiplication, a voltage, or a refresh cycle time of a memory unit of the electronic device.

18. The system of claim 17, wherein the adjustment of the parameter is performed by reducing the frequency-multiplication.

19. The system of claim 17, wherein the adjustment of the parameter is performed by raising the voltage.

20. The system of claim 17, wherein the adjustment of the parameter is performed by raising the refresh cycle time of a memory unit.

21. The system of claim 13, wherein the frequency adjustment module further determines a frequency-multiplication of the electronic device as a plurality of specific frequency-multiplication values, boots the electronic device according to each of the specific frequency-multiplication values, increases the external frequency of the electronic device from the initial frequency until a processing unit fails to properly operate, records a specific frequency value as the external frequency, wherein the recorded specific frequency value is the maximum frequency value at which the processing unit can properly operate, selects one of the specific frequency-multiplication values corresponding to the maximum specific frequency value among the recorded specific frequency values corresponding to the respective specific frequency-multiplication values, boots the electronic device based on the selected specific frequency-multiplication value, and re-performs the adjustment process of the external frequency.

22. The system of claim 13, wherein the peripheral device comprises a memory unit, a display unit, a south bridge chip, or a north bridge chip.

23. An external frequency adjustment system for use in an electronic device, comprising:
a processing unit; and
a frequency adjustment module determining a frequency-multiplication of the electronic device as a plurality of specific frequency-multiplication values, booting the electronic device according to each of the specific frequency-multiplication values, increasing an external frequency of the electronic device from an initial frequency until a processing unit fails to properly operate, recording a specific frequency value, wherein the recorded specific frequency value is the maximum frequency value at which the processing unit can properly operate as the external frequency, selecting the maximum specific frequency value from the specific frequency values corresponding to the respective specific frequency-multiplication values, and setting the maximum specific frequency value as the external frequency.

24. The system of claim 23, wherein the frequency adjustment module further boots the electronic device based on the specific frequency-multiplication value corresponding to the maximum specific frequency value, and re-performs the adjustment process of the external frequency.

25. A machine-readable storage medium comprising a computer program, which, when executed, causes a device comprising a processing unit and at least one peripheral device to perform an external frequency adjustment method, and the method comprises:
increasing an external frequency of the device from an initial frequency until a processing unit fails to properly operate, and recording a maximum first frequency value at which the processing unit can properly operate as the external frequency;
enabling the device to reboot, and initiating and operating the peripheral device according to the first frequency value;
determining whether the peripheral device is properly operating at the first frequency value; and
when the peripheral device can not properly operate at the first frequency value, enabling the device to reboot, subtracting a predefined value from the first frequency value to obtain a second frequency value, and setting the second frequency value as the external frequency, wherein the second frequency value is the maximum frequency value at which the processing unit can properly operate.

26. A machine-readable storage medium comprising a computer program, which, when executed, causes a device comprising a processing unit to perform an external frequency adjustment method, and the method comprises:
determining a frequency-multiplication of the electronic device as a plurality of specific frequency-multiplication values;
booting the electronic device according to each of the specific frequency-multiplication values, increasing an external frequency of the electronic device from an initial frequency until a processing unit fails to properly operate, and recording a specific frequency value, wherein the recorded specific frequency value is the maximum frequency value at which the processing unit can properly operate as the external frequency;
selecting the maximum specific frequency value from the specific frequency values corresponding to the respective specific frequency-multiplication values; and
setting the maximum specific frequency value as the external frequency.
